(19) United States
(12) Patent Application Publication
(10) Pub. No.: US 2021/0355744 A1
(43) Pub. Date: Nov. 18, 2021

(54) SASH APPARATUS AND METHOD OF MAKING SAME

(71) Applicant: Vinyl Window Designs, Toronto (CA)

(72) Inventors: Boulos ALKHOURY, Mount Albert (CA); Pasqualino D'UVA, North York (CA)

(21) Appl. No.: 16/875,871

(22) Filed: May 15, 2020

(51) Int. Cl. E06B 3/263; E06B 3/22

(52) U.S. Cl. CPC E06B 3/2632; E06B 2003/26321; E06B 3/22

(57) ABSTRACT

There is provided a sash apparatus for securing in a window or a door, and a methods making same. The sash apparatus comprises a frame with multiple segments securable to the window or door, where each of the segments has an internal passage therein. The multiple segments are arranged and coupled together at non-straight angles to form the frame, with the internal passages within the segments in fluid communication with one another. The sash apparatus also includes a bonding fill at least partially filling the internal passages within the frame to hold the multiple segments together.

### FIELD

This invention relates generally to window and door components. More specifically, the invention relates to a sash apparatus for securing in windows and doors, and a method of making same.

### BACKGROUND

A sash is the part of a window or door that holds the glass panes together. The sash fits inside the window or door frame, which is attached to the house. Conventional window or door sashes typically involve inner and outer components that collectively grasp the glass panes therebetween. When the components are metal, one or more small plastic inserts are often situated between the inner and outer metal components to reduce heat transfer.

However, such plastic inserts generally create short gaps between the metal extrusions, thus continuing to allow a degree of heat conduction. They also tend to maintain an air gap in the hollow space inside. Overall, conventional sashes tend to involve numerous components, resulting in a generally fragile assembly with numerous potential points of failure.

### SUMMARY

In one aspect of the invention there is provided sash apparatus for securing in a window or a door, the sash apparatus comprising: a frame with multiple segments securable to the window or door, each of the segments having an internal passage therein; the multiple segments being arranged and coupled together at non-straight angles to form the frame, with the internal passages within the segments in fluid communication with one another; and a bonding fill at least partially filling the internal passages within the frame to hold the multiple segments together.

In another aspect of the invention there is provided a method of forming a sash apparatus for securing in a window or a door, the method comprising: providing a frame with multiple segments securable to the window or door, each of the segments having an internal passage therein, the multiple segments being arranged and coupled together at non-straight angles to form the frame, with the internal passages within the segments in fluid communication with one another; filling, at least partially, the internal passages within the frame with a bonding fill; and curing the bonding fill to hold the multiple segments together.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a front view of a conventional sliding door assembly with a typical glass door panel.

FIG. 2 is an enlarged, cross-sectional view along line 2-2 of FIG. 1.

FIG. 3 is an enlarged view of portion A of FIG. 2.

FIG. 4 is a front view of a sash apparatus according to an embodiment of the present invention.

FIG. 5 is an enlarged, cross-sectional view along line 5-5 of FIG. 4 without adhesive fill.

FIG. 6 is a view of FIG. 5 with adhesive fill.

FIG. 7 is a flowchart illustrating an exemplary method by which the sash apparatus of FIG. 4 may be made.

### DESCRIPTION

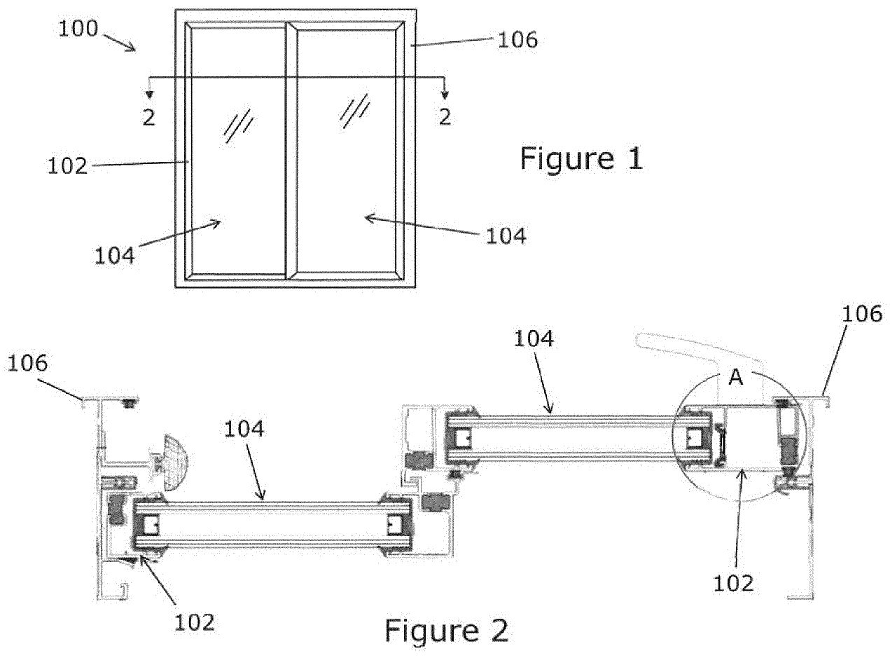

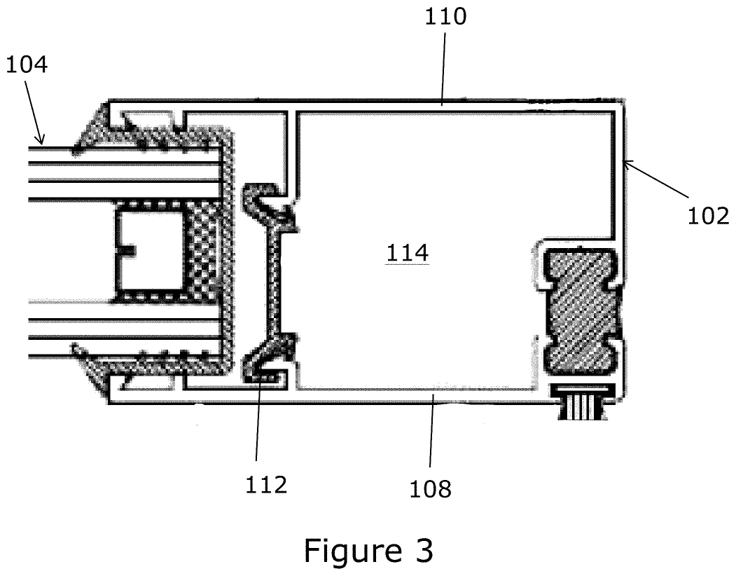

FIGS. 1-3 illustrate a typical sliding door assembly 100 with a conventional door sash or glass door panel 102. As noted above, glass door panel 102 holds glass panes 104 together inside a door frame 106, which is attached to the house (not shown). Glass door panel 102 is depicted to include inner and outer metal components, respectively 108, 110, which collectively grasp glass panes 104 therebetween. There is also a gap or empty space 114 between metal components 108, 110. A small plastic insert 112 is shown situated between inner and outer metal components 108, 110 to reduce heat transfer. However, as also noted above, conventional glass door panel 102 tends to involve many components, resulting in a generally fragile assembly with numerous potential points of failure.

The present invention may be embodied in a number of different forms. The specification and drawings that follow describe and disclose some of the specific forms of the invention.

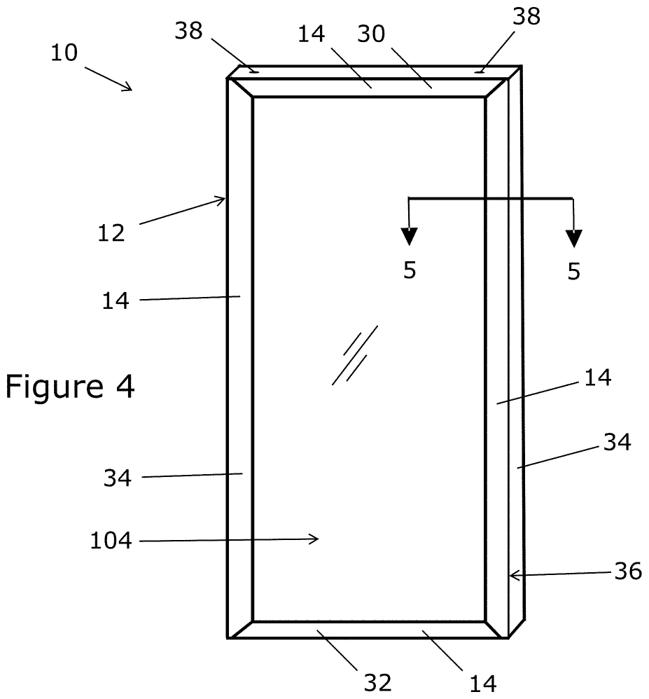

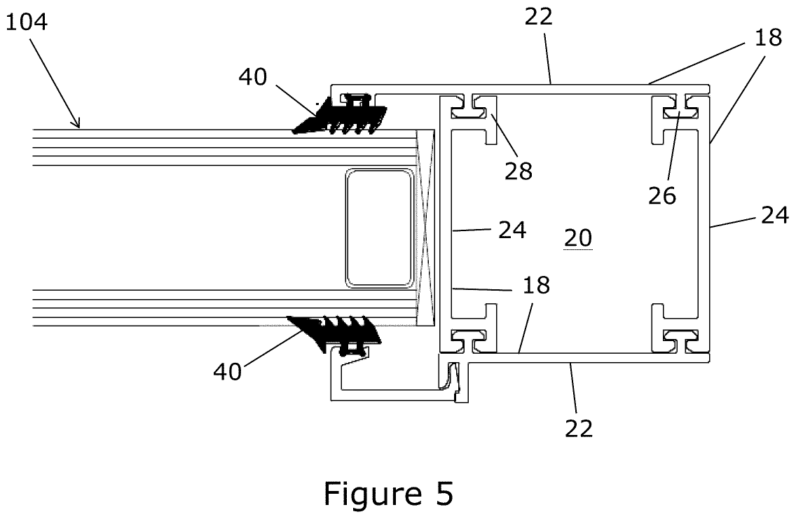

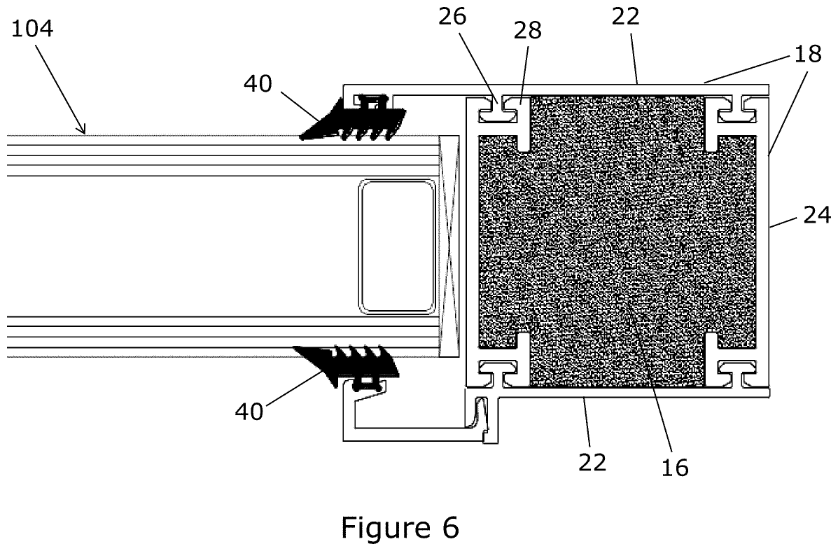

The present disclosure relates to a sash apparatus 10 for securing in a window or a door. As shown in the embodiment of FIGS. 4-6, sash apparatus 10 generally includes a frame 12 with multiple segments 14 that are securable to the window or door, a bonding fill 16, and a glass unit or glass panes 104.

Notably, each segment 14 has as an internal passage 20 therein. For example, each segment may be a single, extruded tubular piece with internal passage 20 situated inside. Alternately, each segment 14 may comprise three or more inserts 18 that are collectively orientated to define internal passage 20 therebetween. In the depicted embodiment, inserts 18 are orientated in parallel with one another and comprise a pair of metal inserts 22, that are spaced apart from one another, and a pair of polymer inserts 24, that are also spaced apart from one another.

Polymer inserts 24 extend between and join metal inserts 22. In this embodiment, metal inserts 22 include T-bars 26, and polymer inserts 26 include tracks 28 which are dimensioned to slidably receive T-bars 26 of metal inserts 22. As understood by the skilled person, other coupling mechanisms may alternately be used to couple polymer inserts 24 with metal inserts 22, such as a snap-fit mechanism or a hooking mechanism.

Polymer inserts 24 generally have a higher heat resistance value than metal inserts 22. In that manner, metal inserts 22 may be made of aluminum, while polymer inserts 24 may be made from vinyl. It will be appreciated that other metal or polymer materials may be used in different embodiments.

In the depicted embodiment, each segment 14 of frame 12 has a rectangular cross-section, in particular, a square cross-section. While a rectangular cross-section is shown, it will be understood that inserts 18 may be orientated to define an internal passage with a different polygonal cross-section, such as a triangular or trapezoidal cross-section.

Multiple segments 14 are further arranged and coupled together at non-straight angles to form frame 12, with internal passages 20 within segments 14 in fluid communication with one another. Multiple segments 14 may include a top segment 30, a bottom segment 32, and two side segments 34 that collectively form a rectangular frame 36 with internal passages 20 also forming a rectangular shape inside. While a rectangular frame is shown, it will be understood that segments 14 may be orientated relative to one another at different angles to result in frames of different dimensions and/or geometries, such as a square, a triangle, a pentagon, etc.

The present case shows frame 12 with glass unit 104 held by metal inserts 22 with gaskets 40. However, sash apparatus 10 may not include glass unit 104.

In the shown embodiment, rectangular frame 36 further comprises a pair of apertures 38 that provide access to internal passages 20 therein. As depicted, apertures 38 are situated in top segment 30, spaced apart from one another on opposite ends of top segment 30. Each aperture 38 may have a diameter between ½″ to ⅜″.

In another embodiment, rather than apertures 38, frame 12 may have an alternate opening (not shown) that provides access from the exterior to internal passages 20. For example, top segment 30 may have three inserts rather than four forming a U-shaped open rectangular polyhedron.

Within internal passages 20, is bonding fill 16. Bonding fill 16 at least partially fills internal passages 20 within frame 12 to hold multiple segments 14 together. In the present embodiment, bonding fill 16 entirely fills internal passages 20 within frame 12 to mechanically and internally hold multiple segments 14 together.

Bonding fill 16 may be an adhesive fill, such as cured epoxy, or a foam fill. In that regard, the bonding fill may be one of a number of flowable substances that has been cured into a solid form to mechanically and/or adhesively hold multiple segments 14 together. In that regard bonding fill 16 is or forms a thermal break with a low thermal transmittance, or U-value, and is integral to the structural part of frame 12.

In an alternate embodiment, internal passages 20 within frame 12 may also contain a second bonding fill with different characteristics and/or qualities than bonding fill 16. The second bonding fill may also be partially filling internal passages 20.

The one or more bonding fills internally hold segments 14 together in the frame configuration, and sash apparatus 10 may be secured to a window or a door.

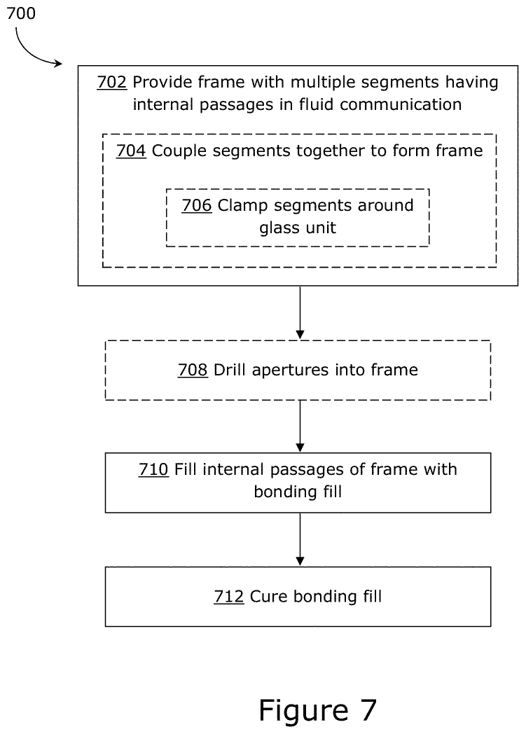

Referring to FIG. 7, there is illustrated an example method 700 for forming or making sash apparatus 10. The following discussion of method 700 is discussed in relation to sash apparatus 10 and, thus, may lead to further understanding of sash apparatus 10. However, it is to be understood that sash apparatus 10 and method 700 can be varied and need not work exactly as discussed herein in relation to each other, and that such variations are within the scope of the appended claims.

At 702, frame 12 with multiple segments 14 is provided. Frame 12 is configured to be securable to the window or door. As noted above, each segment 14 has an internal passage therein. For example, each segment may comprise a single extruded tubular piece with internal passage 20 situated inside, or three or more inserts 18 that are collectively orientated to define internal passage 20 therebetween.

Optionally, at 704, method 700 may comprise assembling segments 14 together to form frame 12. In that regard, 704 may comprise coupling metal inserts 22 to polymer inserts 24, such that polymer inserts 24 extend between and join metal inserts 22. Multiple segments 14 may then, in turn, be arranged and coupled together at non-straight angles to form frame 12, with internal passages 20 within segments 14 in fluid communication with one another. Segments 14 may be clamped together, and/or otherwise sealed, to reduce the presence of gaps between segments 14.

In the present embodiment, inserts 18 are assembled into a polyhedron with a rectangular cross-section, specifically a square cross-section. Segments 14 are, in turn, arranged and coupled together at right angles to form rectangular frame 36, with top segment 30, bottom segment 32, and two side segments 34.

At 706, when assembling segments 14 individually, and assembling segments 14 collectively together to form frame 12, segments 14 may further be coupled and clamped around glass unit 104 with gaskets. In that manner, glass unit 104 may be situated within frame 12, as known in the art.

In an alternate application, rather than assembling frame 12, frame 12 may be purchased from a third-party, with or without glass unit 104. In that regard, existing or known window or door sashes may be modified to have fluidly connected internal passages, and used in method 700 to form sash apparatus 10.

At 708, method 700 may further comprise drilling apertures 38 into frame 12, where apertures 38 provide access to internal passages therein. In the present embodiment, a pair of apertures are drilled into the top insert of top segment 30 of frame 12, with one aperture 38 positioned at one end of top segment 30, and the other aperture 38 positioned at the opposite end of top segment 30. Each aperture 38 may have a diameter between ½″ to ⅜″.

In cases where frame 12 already has an existing opening that provides access to internal passages from the exterior, the drilling described above may not be necessary.

At 710, internal passages 20 within frame 12 are filled, at least partially, with bonding fill 16 to hold multiple segments 14 together. If frame 12 has apertures 38, the filling comprises injecting bonding fill 16 through one of the apertures into internal passages 20 of frame 12. Since internal passages 20 are all in fluid communication with one another, and since bonding fill is a flowable substance, bonding fill 16 introduced into internal passages 20 will tend to flow from one internal passage to another.

For example, if bonding fill 16 is a liquid epoxy, the liquid epoxy may be injected through one of apertures 38 in top segment 30. Since top segment 30 is positioned at the top of frame 12, gravity would cause the liquid epoxy to flow through internal passages 20 down into internal passage 20 of bottom segment 32. There, the liquid epoxy would begin to fill internal passage 20 of bottom segment 32, including filling air gaps and/or creases between metal inserts 22 and polymer inserts 24, and between segments 14.

The liquid epoxy would then continue to fill internal passages 20 of side segments 34, and then finally fill internal passage 20 of top segment 30. Once the liquid epoxy can be seen at the other one of apertures 38, this indicates to the user that all of internal passages 20 in frame 12 have been fully filled with the liquid epoxy.

It would be understood that internal passages 12 may be partially or mostly filled with bonding fill 16, depending on the type of bonding fill used. For example, bonding fill 16 may be of the variety that expands in volume upon curing. In such a case, internal passages 12 need only be partially filled with uncured bonding fill 12 at the filling stage.

In another embodiment, the user may wish that one bonding fill, with specific characteristics or qualities, sit within a certain section of frame 12, and a second bonding fill, with different characteristics or qualities, sit within a different section of frame 12. In such a case, partial filling with the two different bonding fills at different stages would also be appropriate.

At 712, bonding fill 16 is cured. Curing changes bonding fill 16 from a flowable state to a generally solid state such that it mechanically and/or adhesively holds multiple segments 14 together internally. The curing step would depend on the type of bonding fill used.

In the liquid epoxy embodiment, curing may simply include drying the liquid epoxy by waiting for the liquid epoxy to solidify. Curing may alternately or additionally involve heating bonding fill 16. Curing could also involve applying an ultra violet (UV) light, or mixing in a solidifying agent to chemically harden bonding fill 16.

Once bonding fill 16 is set or cured, the solidified bonding fill 16 internally holds segments 14 together, and sash apparatus 10 may be secured to a window or door.

The presently disclosed apparatus and method may have a number of advantages over conventional sashes. The internal solidified bonding fill helps to connect the frame segments together without the need for additional fastening components, such as screws. This may help to reduce the potential points of failure in the assembly.

The presence of the solidified bonding fill between the metal inserts helps to improve insulation. In fact, the type of bonding fill used may be specifically selected for its insulating properties once cured. Examples of such a bonding fill include epoxy or polyurethane.

The presence of the solidified bonding fill may also improve the overall strength of the sash apparatus. The presence of the solidified bonding fill within the frame may help to prevent bending or denting of the sash. The type of bonding fill used may also be specifically selected for its weight, strength and/or flexibility once cured. In that regard, a variety of PU foams may be used as the bonding fill. The PU foam can be made or selected to be extremely rigid or flexible, with good thermal properties.

It is to be understood that what has been described are the preferred embodiments of the invention. The scope of the claims should not be limited by the preferred embodiments set forth above, but should be given the broadest interpretation consistent with the description as a whole.

1. A sash apparatus for securing in a window or a door, the sash apparatus comprising:
a frame with multiple segments securable to the window or door, each of the segments having an internal passage therein;
the multiple segments being arranged and coupled together at non-straight angles to form the frame, with the internal passages within the segments in fluid communication with one another; and
a bonding fill at least partially filling the internal passages within the frame to hold the multiple segments together.

2. The sash apparatus of claim 1, wherein each of the segments comprises:
a pair of metal inserts spaced apart from one another; and
a pair of polymer inserts extending between and joining the pair of metal inserts,
the inserts collectively orientated to define the internal passage therein.

3. The sash apparatus of claim 1, wherein the frame further comprises a pair of apertures that provide access to the internal passages therein.

4. The sash apparatus of claim 3, wherein the bonding fill entirely fills the internal passages within the frame.

5. The sash apparatus of claim 4, wherein the bonding fill is cured epoxy.

6. The sash apparatus of claim 5, wherein each segment of the frame has a rectangular cross-section, and the multiple segments comprise a top segment, a bottom segment, and two side segments that collectively form a rectangular frame.

7. The sash apparatus of claim 6, further comprising a glass unit secured within the frame by the metal inserts.

8. The sash apparatus of claim 7, wherein the pair of apertures is positioned in the top segment.

9. The sash apparatus of claim 8, wherein the pair of apertures is spaced apart at opposite ends of the top segment.

10. The sash apparatus of claim 1, further comprising a second bonding fill at least partially filling the internal passages within the frame.

11. A method of forming a sash apparatus for securing in a window or a door, the method comprising:
providing a frame with multiple segments securable to the window or door, each of the segments having an internal passage therein, the multiple segments being arranged and coupled together at non-straight angles to form the frame, with the internal passages within the segments in fluid communication with one another;
filling, at least partially, the internal passages within the frame with a bonding fill; and
curing the bonding fill to hold the multiple segments together.

12. The method of claim 11, wherein each segment comprises:
a pair of metal inserts spaced apart from one another; and
a pair of polymer inserts extending between and joining the pair of metal inserts,
the inserts collectively orientated to define the internal passage therein.

13. The method of claim 12, further comprising drilling a pair of apertures into the frame prior to the filling, the apertures providing access to the internal passages therein.

14. The method of claim 13, wherein the filling comprises injecting the bonding fill through one of the apertures into the internal passages of the frame.

15. The method of claim 14, wherein the filling comprises entirely filling the internal passages within the frame.

16. The method of claim 15, wherein the providing comprises assembling the segments together to form the frame.

17. The method of claim 16, wherein the providing further comprises assembling each segment of the frame to have a rectangular cross-section, and wherein the multiple segments comprise a top segment, a bottom segment, and two side segments that collectively form a rectangular frame.

18. The method of claim 17, wherein the providing further comprises clamping the segments together around a glass unit.

19. The method of claim 18, wherein the drilling comprises drilling the pair of apertures into the top segment of the frame.

20. The method of claim 11, further comprising filling, at least partially, the internal passages within the frame with a second bonding fill; and
curing the second bonding fill.
